(19) United States
(12) Patent Application Publication
(10) Pub. No.: US 2002/0178064 A1
(43) Pub. Date: Nov. 28, 2002

(54) Method and system for processing charity contribution

(75) Inventor: Katsunori Yanase, Taito-ku (JP)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Earth Sector International, Inc., New York, NY

(21) Appl. No.: 09/908,222

(22) Filed: Jul. 17, 2001

(30) Foreign Application Priority Data
May 23, 2001 (JP) 2000-154612

(51) Int. Cl. G06F 17/60

(52) U.S. Cl. 705/17; 705/39

(57) ABSTRACT

A system comprising a purchase information receiving unit for receiving item purchase information including the information of a store at which a purchaser purchases an item using a credit card and the information of the purchase cost at said store, a contribution condition determining unit for searching whether or not the store is a member who agrees to a contribution to a charity (NPO) and determines contribution conditions such as the algorithm for determining its amount of contribution and the designated charity when the store is such a member, and a contribution execution processing unit for paying the amount in which said algorithm is applied to the purchase cost to the designated charity as the amount of contribution.

### BACKGROUND OF THE INVENTION

1. Field of the Invention

The present invention relates to a method and a system for making charity donation using a credit/charge, and more particularly to a method and a system that is capable of collecting contributions from not only cardholders but also stores that sell goods and manufactures of products.

2. Description of the Related Art

In recent years, banks and credit card companies have provided various supplementary services in addition to the primary service of account settlements in order to give cardholders incentive to use their cards. One of such services is that a cardholder can donate a given amount of money to a predetermined specific non-profit organization (NPO) or crisis at the time of a card purchase. Such service provides an advantage that makes donations easy for consumers who have a high awareness of contributing to society.

However, according to the above service, a person, who contributes to a charity, is limited to a cardholder, who is the purchaser of goods. On the other hand, there are individuals and companies that have a high awareness of contributing to society among sellers and manufactures. The conventional service cannot provide cardholders' shopping time as an opportunity for such persons to make contributions.

### SUMMARY OF THE INVENTION

The present invention has been made with consideration given to the aforementioned circumstances, and an object of the present invention is to provide a method and a system that give an opportunity for charity donations with respect to sellers and manufactures, who have high awareness of contributing to society, based on a predetermined agreement on contributing to a charity, at the time when a purchaser buys an item or service using a credit card and others, whereby increasing donations to charities.

In order to attain the above-mentioned object, the first aspect of the present invention provides a method comprising the steps of (a) receiving the charge for a cost relating to a purchase concerned from a store where a purchaser purchases an item or service using a credit/charge; (b) searching whether or not said store or manufacturer of said item or service is a member that agrees to a contribution to a charity and determining the algorithm to determine its amount of contribution and the designated charity for the contribution when the store or manufacturer is such a member; and (c) paying the amount in which the algorithm determined in the step (b) is applied to the cost relating to the purchase to said designated charity determined in the step (b) as the amount of contribution.

According to this method, in the case where a purchaser buys an item using a credit card, debit card, and others at a business place such as a store, a charity contribution is performed based on the fact whether or not the store or manufacturer concerned agrees to a charity contribution. As a result, even if the purchaser of the item does not agree to a charity contribution, the charity contribution is carried out. This makes it possible to increase opportunities for fund-raising as compared with the conventional methods of fund-raising using credit cards. Incidentally, charities are preferably non-profit organizations (NPO) but not limited to NPOs.

According to one embodiment of the present invention, the step (c) may be performed to pay the amount of contribution to the designated charity as the contribution of the store or/and manufacturer. Or, the step (c) may be performed to pay the amount of contribution to the contribution charity as the contribution of the purchaser.

According to this configuration, the contribution can be performed in the name of the store/manufacturer and that of purchaser regardless of who actually pays the amount of contribution.

According to another embodiment, the method further comprises the step (d) of paying the amount obtained by subtracting the amount of contribution from the cost relating to the charge. In this case, the step (d) preferably includes the step of issuing details of the purchase amount relating to the payment and details of the amount of contribution to the designated charity.

According to this configuration, it is possible to burden the store with the amount of contribution. This makes it possible to execute the contribution at the store's expense without burdening the purchaser of the item with the amount of contribution. In this case, the store can receive the details relating to the contribution.

According to still another embodiment, the method further comprises the step (e) of notifying the purchaser of the information of which the contribution concerning the purchase of the purchaser is performed.

According to this configuration, it is possible to notify the purchaser of information of the amount of contribution and designated charity regardless of whether or not the purchaser agrees to the contribution.

According to still another embodiment, the method further comprises the step of (f) receiving details of the item relating to the purchase concerned, wherein the above mentioned step (b) searches whether or not the manufacturer of the item is a member that agrees to a contribution to a charity based on the details and determines the algorithm for determining its amount of contribution and the designated charity for the contribution when the manufacturer is such a member.

According to this method, a fund-raising can also be executed when the manufacturer of the item agrees to a contribution to a charity. This makes it possible to further increase the opportunity for fund-raising.

According to still another embodiment, the method further comprises the steps of: (g) searching whether or not the purchaser of an item is a member that agrees to a contribution to a charity and determining the algorithm to determine its amount of contribution and the designated charity for the contribution when the purchaser is such a member; (h) paying the amount in which the algorithm is applied to the item's purchase cost relating to the purchase of the purchaser to the said designated charity as the amount of contribution from the purchaser; and (i) charging the purchaser for the amount obtained by adding the amount of contribution to the purchase cost. In this case, the algorithm for determining the amount of contribution of the store determined in the step (b) is set such that the amount of contribution of the store or manufacturer is preferably a predetermined percentage of the amount of contribution by the purchaser or the same as the amount of contribution by the purchaser. Moreover, the algorithm for determining the amount of contribution of the purchaser determined in the step (g) is set such that the amount of contribution of the purchaser is preferably a predetermined percentage of the amount of contribution from the store/manufacturer or the same as the amount of contribution from the store.

According to this method, a fund-raising can also be executed, not only when the store or the manufacturer agrees to a contribution to a charity but also when the purchaser agrees to a contribution to a charity. This makes it possible to further increase the opportunity for fund-raising. Moreover, in this case, the store/manufacturer's amount of contribution is conformed to the purchaser's amount of contribution, making it possible to implement the so-called matching gift type contribution in which the store or manufacturer can match the purchaser's contribution amount for the total contribution.

According to still another embodiment, the step (b) determines the designated charity of the purchaser determined in the step (g) as the designated charity of the store or manufacturer. Also, the step (g) determines the designated charity of the store determined in the step (b) as the designated charity of the purchaser.

According to this configuration, when the store (or manufacturer) and purchaser are members, who have agreed to charity contributions, the designated charity selected by either the store/manufacturer or the purchaser is automatically determined as the designated charity of the others.

According to still another embodiment, the step (c) is performed to pay a part of the contribution amount to the above-mentioned designated charity as the contribution of the above-mentioned store or manufacturer and the other part of the contribution amount to the above-mentioned designated charity as the contribution of the purchaser.

According to this configuration, a part of the contribution amount of the store or manufacturer can be paid to the designated charity in the name of the purchaser.

In the second aspect of the present invention provides a system for promoting a contribution to a charity in association with a purchase using a credit/charge, the system comprising a purchase information receiving means for receiving purchaser's purchase information of an item or service using a credit/charge wherein the purchase information includes at least the information of the store at which the purchaser performs the purchase and the information of the purchase cost at the store; a contribution condition determining means for searching whether or not the store or manufacturer is a member who agrees to a contribution to a charity and determining contribution conditions such as the algorithm for determining its amount of contribution and the designated charity for the contribution when the store or manufacturer is such a member; and a contribution amount payment processing means for paying the amount which the algorithm is applied to the purchase cost to the designated charity as the amount of contribution.

According to this configuration, it is possible to obtain the system that can implement the method in the first aspect.

The other features and notable effects of the present invention will become readily apparent by the following description and the accompanying drawings.

### BRIEF DESCRIPTION OF THE DRAWINGS

FIG. 1 is a schematic configuration diagram illustrating one embodiment of the present invention;

FIG. 2 is a view illustrating an example of a format for storing item purchase information;

FIG. 3 is a view illustrating an example of a contribution condition judging table;

FIG. 4 is a view illustrating a donation pattern for each contribution type code;

FIG. 5 is a flowchart illustrating a processing procedure at an item purchasing time;

FIG. 6 is a flowchart illustrating a processing procedure for determining a contribution condition of a contributor;

FIG. 7 is a view illustrating an example that determines the contribution condition of the contributor;

FIG. 8 is a flowchart illustrating a procedure for processing an amount of payment and an amount of charge for each contributor;

FIG. 9 is a view illustrating an example in which the amount of payment and the amount of charge for each contributor are added up;

FIG. 10 is a flowchart illustrating a processing procedure at an item purchasing time; and

FIG. 11 is a view illustrating the contribution amount for each NPO is added up.

FIGS. 12A and 12B are schematic configuration diagrams illustrating another embodiment of this invention.

FIGS. 13A to 13C are diagrams illustrating a format example of various information of the same embodiment.

### DETAILED DESCRIPTION OF THE PREFERRED EMBODIMENT

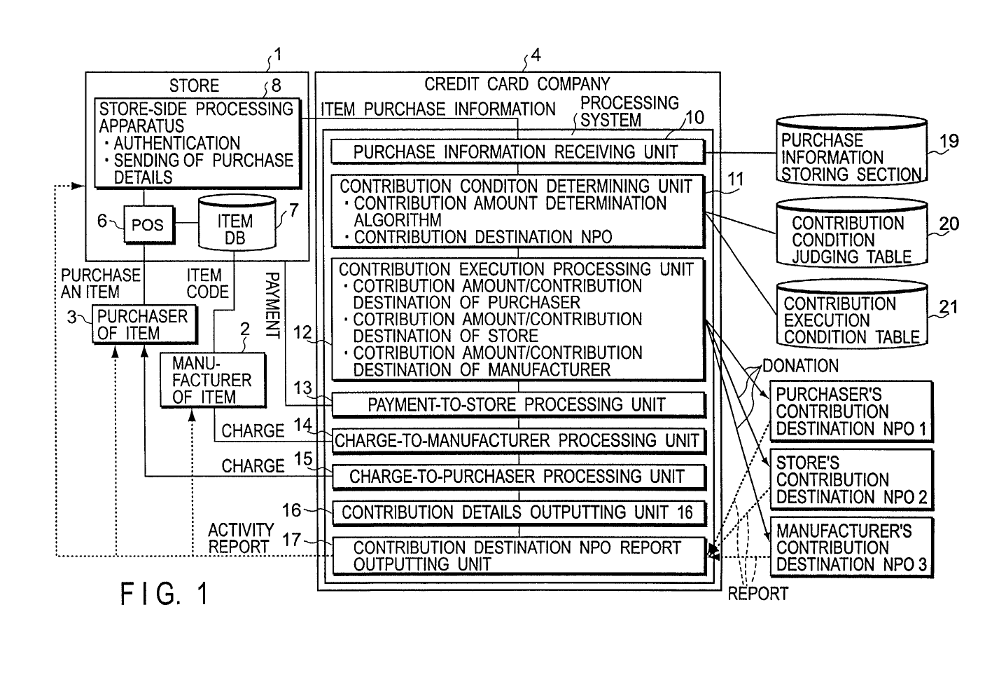

FIG. 1 is a schematic configuration diagram illustrating one embodiment of the present invention.

Reference numeral 1 in FIG. 1 indicates a store as a businessperson who sells a purchaser 3 an item manufactured by a manufacturer 2. Reference 4 indicates a credit card company for processing the credit card settlement at the store 1.

First, the store 1 has a POS system 6 for settling an account for the item that the purchaser 3 intends to buy. The POS system 6 preferably has a bar code input system that scans the code of this item at the time of payment. An item database 7, which stores item information of the store 1 with the item code, is connected to the POS system 6. This POS system 6 has a function of reading information about item cost, item manufacture 2, item classification, and the like at the time of payment. Among item information, at least the item code is one that is supplied from the item manufacture 2 and is preferably consistent with the one in the item database (not shown), which the manufacture 2 has.

Moreover, a credit card/debit card reading apparatus (not shown) is attached to the POS system 6, so that the payment of the item can be handled by a credit card or debit card. Then, the card reading apparatus is connected to a store-side processing apparatus 8 for performing authentication of the card and transmission of data (purchase information) relating to the purchase of the item. The store-side processing apparatus 8 performs authentication of the credit card and transmits the above-mentioned purchase amount and details of the purchase item to the credit company 4 with the item code when authentication is positive.

When the store 1, where the POS system 5 is set up, agrees to a contribution to an NPO (non-profit organization), the purchaser 3 can choose from at least two “contribution types” at the time of payment. Namely, the purchaser 3 can select either (A) where a contribution is made to NPO1 selected by the purchaser 3 or (B) where a contribution is made to NPO2 selected by the store 1. Additionally, in the case where the manufacture 2 of the purchased item agrees to a contribution to an NPO, the purchaser 3 can select (C) where a contribution is made to NPO3 selected by the manufacturer 2. Among these, (B) and (C) are the so-called “matching gift” format in which a donation amount of purchaser 3 is contributed to the contribution destination NPO 3 selected by the store 1 or the manufacturer 2 together with a donation amount of store 1 or manufacturer 2. Such selection information of contribution type is also transmitted to the credit card company 4 from the POS system 6.

In connection with the credit card company 4, only the configuration relating to this invention will be explained. The credit card company 4 has a purchase information receiving unit 10, a contribution condition determining unit 11, and a contribution execution processing unit 12. The purchase information receiving unit 10 receives item purchase information transmitted from the store-side processing apparatus 8. The contribution condition determining unit 11 selectively determines contribution conditions of the store 1, purchaser 3, and manufacturer 3. The contribution execution processing unit 12 executes a contribution in accordance with the contribution condition determined by the contribution condition determining unit 11.

The purchase information-receiving unit 10 stores the received item purchase information in a purchase information storing section 19. The contribution condition determining unit 11 applies the information stored in the purchase information storing section to a contribution condition judging table 20 in order to determine contribution conditions of the above-mentioned store 1, purchaser 3, and manufacturer 2, specifically the algorithm for determining respective contribution amounts and contribution destination NPOs. The credit card company 4 also has a member information table for performing card authentication though this is not shown in the figure.

Then, the contribution execution-processing unit 12 determines the respective contribution amount of the store 1, purchaser 3, and manufacturer 2 and the contribution destinations in accordance with the contribution condition determined by the contribution condition-determining unit 11. These determined contribution conditions are stored in a contribution execution condition table 21, and the contribution-execution processing unit 12 executes contribution processing with respect to the contribution conditions.

The credit card company 4 further comprises a payment-to-store processing unit 13, a charge-to-manufacturer processing unit 14, a charge-to-purchaser processing unit 15, a contribution details outputting unit 16, and a NPO report-outputting unit 17. The payment-to-store processing unit 13 subtracts the contribution amount of the store 1 from the credit/charge amount, and executes the processing of the payment to the store 1. The charge-to-manufacturer processing unit 14 executes the processing of charging the manufacturer 2 for the contribution amount of the manufacturer 2. The charge-to-purchaser processing unit 15 adds the contribution amount of purchaser to the credit/charge amount and executes the processing of charging the purchaser 3 for the contribution amount. The contribution details outputting unit 16 outputs the details of the respective contributions of the store 1, manufacturer 2, and purchaser 3. The NPO report outputting unit 17 outputs activity reports of the contribution destination NPOs to which each of the store 1, manufacturer 2, and purchaser 3 has contributed.

If the store is one that has agreed to the contribution to NPO, the payment-to-store processing unit 13 determines the amount of payment to the store by subtracting the store's contribution amount to NPO and the credit company's commission from the sales amount of the store concerned.

Similarly, if the manufacturer and purchaser have agreed to a contribution, the charge-to-manufacturer processing unit 14 and the charge-to-purchaser processing unit 15 charge the contribution amounts determined by the contribution condition determining unit 11 and the contribution-execution processing unit 12 to the manufacturer and purchaser, respectively.

The payment processing to the store or the charge processing to the manufacturer and the purchaser is performed by the respective processing units 13 to 15 at the same time with the determination of the amount of contribution to NPO or the different time from the determination thereof in a given cycle (for example, one-month cycle). Then, at the time of performing the payment or charge processing, the contribution details outputting unit 16 prepares and outputs details for each of the store, manufacturer, and purchaser, and notifies the corresponding person of such details together with the purchase details of the item. This makes it possible for the contributors to grasp the contents of contribution periodically, adding incentive to a next contribution.

On the other hand, the NPO report outputting unit 17 receives an activity status from NPO1, which is the contribution destination of the purchaser, NPO2, which is the contribution destination of the store, and NPO3, which is the contribution destination of the manufacturer, and prepares and outputs reports, and sends them to respective contributors. This makes it possible for a contributor to check the activity status of the NPO to which the contributor made a donation, adding an incentive to the next contribution. This also provides an opportunity to review contribution destinations. This report may be sent at the same with the notification of the details of contribution or with different timing. The former can reduce the load on the notification and report work and the latter can increase the opportunities for the contributors to become conscious of contributions to NPOs.

These structural components 10 to 17 are actually fixed areas reserved in a storage medium and programs installed to these areas. They are called up onto RAM by a CPU (not shown) and executed, whereby the function of this invention is performed in cooperation with OS (Operation System).

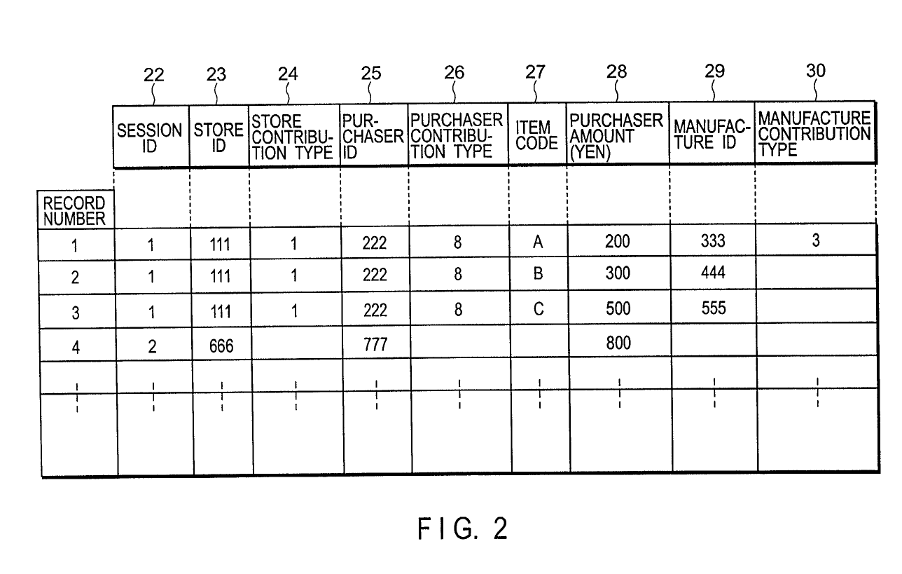

An explanation will be next given of a format example of item purchase information, which is transmitted from the store 1 and which is received by the purchase information receiving unit 10, with reference to FIG. 2.

As illustrated in FIG. 2, item purchase information consists of the respective fields of a session ID 22 for referring to a settlement unit at the POS 6, a store ID 23 for specifying the sore 1, a store contribution type 24, a purchaser ID 25 for specifying a purchaser, a purchaser contribution type 26, an item code 27 for specifying the purchasing item, purchase amount 28 of the corresponding item, a manufacturer ID 29 for specifying the manufacturer of an item, and a manufacturer contribution type 30. Then, a record number as a key for searching is added for each record.

If multiple item codes can be obtained from the store 1, as in session ID=1, the number of records to be checked by the same session ID is more than one in some instances. In this case, an amount obtained by adding up all purchase amounts of the plurality of records becomes an adjusted amount at the store 1.

If no item code can be obtained, the number of records to be checked by one session ID is only one. A value is not always inputted to each field. For example, as in the record of section ID=2, even when no contribution type is inputted, the contribution is executed by the contribution type where a default value is set, which will be described later.

Then, as to whether each of the store checked by store ID, the purchaser checked by purchaser ID and the manufacturer checked by manufacturer ID is a member who has agreed to a contribution to a NPO or not, is determined with reference to the contribution condition judging table 20 to be next explained. The contribution condition of each of the store, purchaser, and manufacturer is determined in accordance with the contribution type code and the algorithm stored in the contribution condition judging table 20.

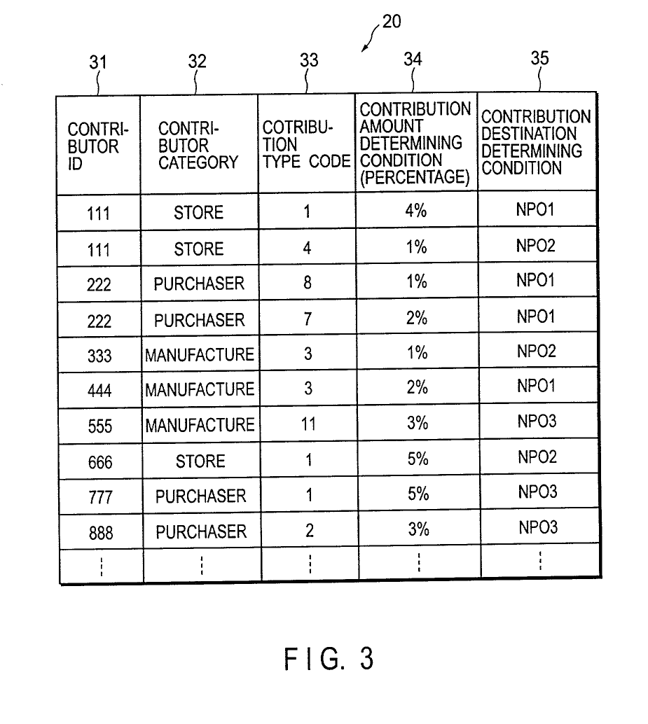

An explanation will be next given of the example of the contribution condition judging table 20 with reference to FIG. 3.

The table 20 has the respective fields of an ID 31 for specifying the store, the purchaser and the manufacturer who have agreed to charity contributions, a contributor category 32, a contribution type code 33 preselected by those parties, the contribution amount determining condition (percentage of the purchase amount) 34 in the selected type, and a contribution destination determining condition (contribution destination NPO) 35 in the selected type.

The contribution type code 33 is one that specifies in advance the intension of the person, who will make a contribution. For example, the contribution type code 33 is used the contribution type code 33 when the contributor of the store uses different contribution conditions for different occasions. For instance, the store of contributor ID 111 selects contribution type codes 1 and 4, and uses the contribution type codes depending on the circumstances. Moreover, in the case where the contributor selects multiple contribution destination NPOs, it can be set that a purchaser may freely decide the distribution of the contribution amount or the purchase amount, which is the basis of the contribution amount. This makes it possible to increase the purchaser's sense of participation.

The contribution condition, which is first set with respect to each contributor, is used as the default contribution condition with respect to the contributor. Here, regarding the contributor who sets multiple contribution conditions as in store ID=111, the default contribution condition is determined in accordance with an optional sorting order of such as the contribution type code, amount of contribution condition (ratio) and the like and the contributor's setting. Concerning contribution type codes, it is preferable that each contributor can freely update them on a homepage set up by the credit card company.

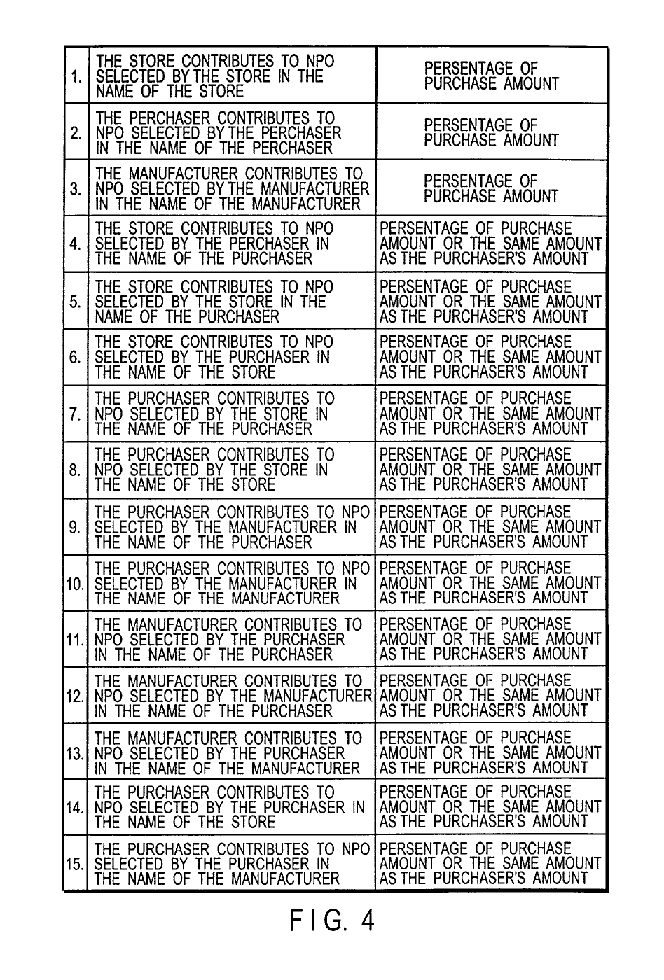

FIG. 4 is a view to explain the meaning of a contribution type code that can be set here.

For example, the contribution type codes=1 to 3 illustrated in this figure are donation patterns in which the store, purchaser, and manufacturer contribute to NPOs that they have selected in their own names, respectively. In this case, an amount of contribution is uniformly determined at a given percentage of the purchase amount. Since the above pattern makes it possible to execute a processing in the simplest way, this pattern is preferably set as the aforementioned default.

The contribution type code=4 and subsequent codes are the case in which two or more parties among the store, purchaser, and manufacturer agree to contributions which is shown in the respective records of the above-mentioned purchase information. For example, the contribution type codes=4 to 6 show the case in which the store that sells the item contributes (donates) but the name of contributor and the selector of the contribution destination NPO are parties other than the store.

The selection of the code 4 and subsequent codes by the person, who contributes, makes it possible to implement the donation pattern like a matching gift. For example, in the case where the store and the purchaser, who have agreed to charity contributions, select contribution type codes=1 and 8, respectively as in secession ID=1 of FIG. 2, the following contribution pattern is executed. Namely, if the purchaser buys an item priced for 10000 Yen, the amount (100 Yen) determined based on the contribution condition (1% of the purchase amount) illustrated in FIG. 3 is donated to NPO1 selected by the store. Concurrently, the same amount (100 Yen) as that of the purchaser is donated to NPO1 selected by the corresponding store from the store in the name of the purchaser.

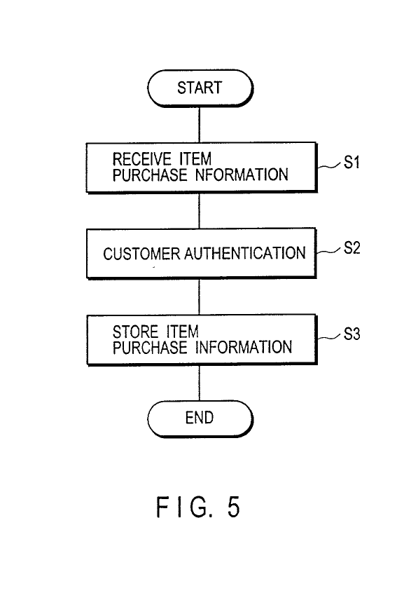

A specific explanation will be next given of the processing procedure of the system provided in the credit card company 4 with reference to the flowchart illustrated in FIGS. 5, 6, 8, and 10. S1 to S21 in this figure correspond to the step numbers (step S1 to step S21) to be shown below.

First, as illustrated in FIG. 5, when a customer purchases an item at the store 1 and pays for the purchased cost through POS 6 provided in the store, the item purchase information fetched from POS 6 is transmitted from the store-side processing apparatus 8 (step S1).

The transmitted item purchase-information is received by a purchase-information receiving unit 10, and a customer authentication section (not shown) performs matching between the received item purchase information and credit information possessed to carry out an authentication for the customer's credit card usage (step S2).

When the authentication is positive, the purchase information receiving unit 10 stores the item purchase information in the purchase information storing section 19 in a state as shown in FIG. 2 for example (step S3). Then, the authentication result is returned to the store by the purchase information receiving unit 10 and this processing is ended.

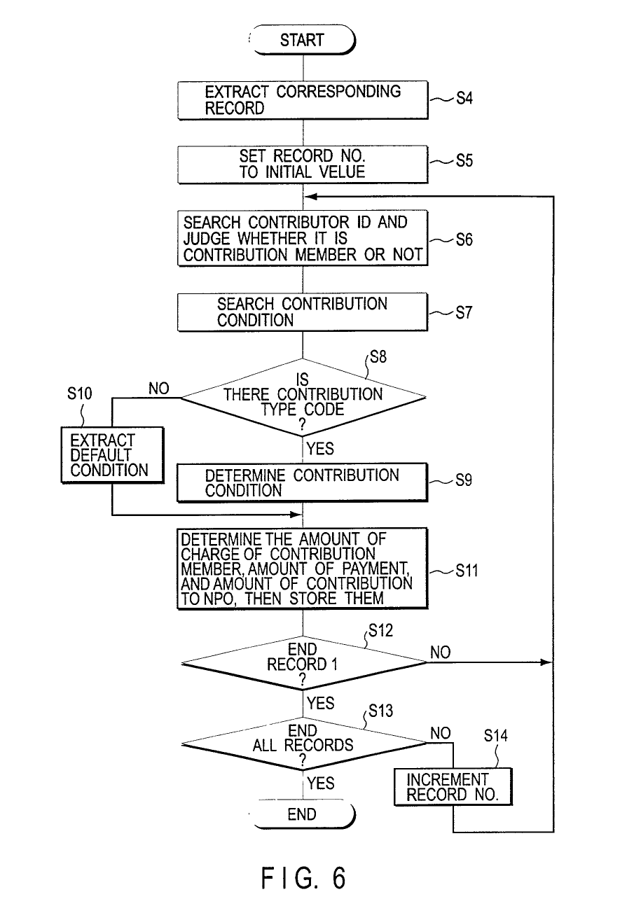

An explanation will be next given of processing for determining the contribution condition of contributing members with reference to the flow chart of FIG. 6. The determination of this contribution condition is preferably carried out at once in a given cycle, for example, once a month.

First, the contribution condition determining unit 11 fetches the first record which is referred by the record number 1 from the item purchase information (FIG. 2) stored in the purchase information storing section 19 and stores it in memory (step S4, step S5). Here, the initial value for record number is set to 1 (step S5). After completing all processing for the records with the record number 1, the records referred by the subsequent record numbers are sequentially processed.

When a record to be processed is fetched, the contribution-condition determining unit 11 determines the contribution condition for the store, purchaser, and manufacturer included in this record (steps S6 to S11). In this example, first, the contribution-condition determining unit 11 determines whether or not the store specified by the store ID 111 is a member that has agreed to the contribution to NPO (step S6). More specifically, the contribution condition determining unit 11 searches the field of the contributor ID 31 in the contribution-condition judging table 20 illustrated in FIG. 3 in order to judge whether or not there is one that matches the store ID 111.

When there is one that matches the store ID 111, the contribution condition determining unit 11 fetches the store's contribution type value (contribution type code) 1 from the purchase information (FIG. 2), and searches the contribution condition from the contribution condition judging table 20 based on the value 1 (step S7, step S8). In this example, the conditions that match the ID 111 and contribution type code 1 can be found out at the top of FIG. 3, and 4% for the amount of contribution determining condition and NPO1 for the contribution destination determining condition are extracted as contribution condition parameters. Then, when they are applied to the algorithm shown in the table of FIG. 4, the contribution condition of this store results in “contribute 4% of the sales amount to NPO1 selected by the store in the name of the store” (step S9).

On the other hand, there is a case in which the value of the contribution type code extracted from the purchase condition is “NULL” or a code that is not stored in the contribution-condition judging table 20. In this case, it is judged that there is no corresponding contribution type code in the contribution condition judging table 20. Then, the contribution condition, which is first referred concerning the corresponding contributor ID, is fetched from the contribution condition judging table 20 as the default condition, and the contribution condition is determined based on the fetched default condition (step S10).

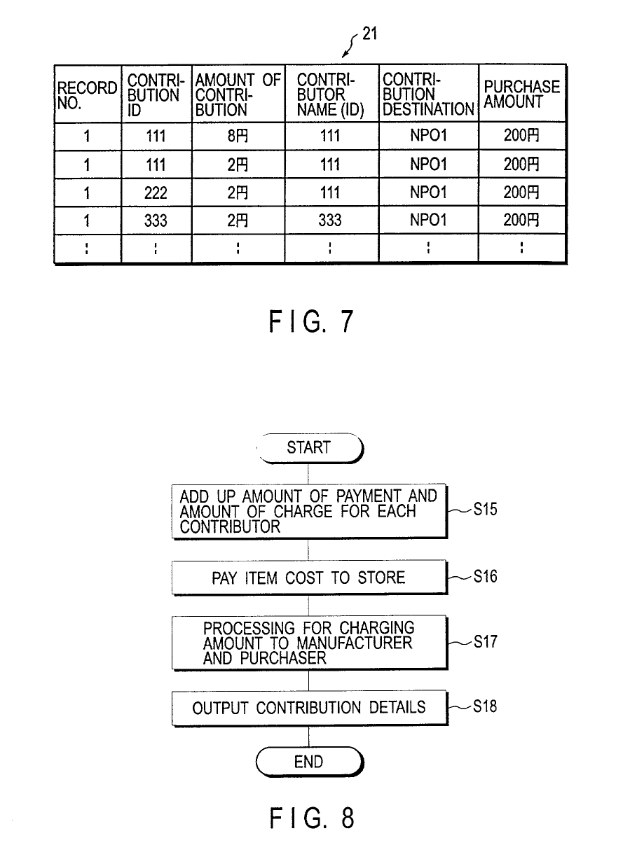

When the actual contribution execution condition is thus determined, the contribution condition determining unit 11 applies this condition to the purchase information and determines an amount of contribution of the store of ID=111, an amount of payment, and an amount of contribution to NPO, and stores them in the contribution execution condition table 21 (step S11). An example of data stored in the contribution execution condition table 21 is shown in FIG. 7. In the example of the store with the store ID (contributor ID) 111 in the record number 1, the contribution condition of “contribute 4% of the sales amount to NPO1 selected by the store in the name of the store” determined in step S9 is applied to the purchase amount 200 Yen of FIG. 3. This determines the specific contribution contents, which are 8 Yen as the contribution amount, Store ID 111 for the contributor, and 1 for the contribution destination NPO as illustrated in FIG. 7. This determines the contribution contents of the store regarding the record concerned.

Next, step S12 judges whether or not the processing of all contributors for the record concerned is completed. If it is not completed, the contribution conditions and the contribution contents relating to the remaining contributors are determined by the same processing as the above (step S6 to step S1). In other words, when the contribution contents of the store are determined, the contribution conditions and the contribution contents relating to the purchaser (purchaser ID=222) of the same record and the manufacturer (manufacturer ID=333) thereof are determined next, and the results are stored in the contribution execution condition table 21 as illustrated in FIG. 7.

Additionally, regarding the purchaser, when the contribution parameters corresponding to purchaser ID=222 and the contribution type code 8 are fetched from the contribution condition judging table 20 and applied to the corresponding algorithm shown in FIG. 4, the contribution condition results in “the purchaser (purchaser ID=222) contributes 1% (2 Yen) of the purchase amount (200 Yen) to NPO (NPO1) selected by the store in the name of the store (store ID=111).” This processing mode implements the so-called matching gift.

After that, in step S12, it is judged that the processing of the record concerned is completed, the contribution condition determining unit sequentially increments the record number and processing in steps S6 to S12 is repeatedly executed until it is judged that the processing of all records is completed in step S13. Whereby, all contribution contents about all contributors who have agreed to charity contributions in the purchase information are stored in the contribution execution table 21.

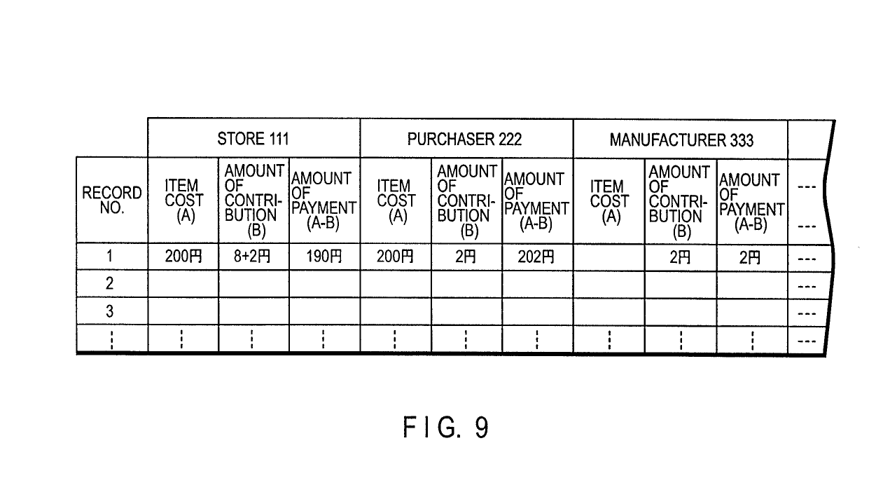

When the contribution content of each contributor is thus determined, charge and payment processing are executed to each of the store, purchaser, and manufacturer. The processing will be explained with reference to FIG. 8 and FIG. 9.

Namely, data stored in the contribution execution condition table 12 by the contribution execution processing unit 12 is totaled up on a record-by-record basis such that the amounts of payment/charge to each of the store, purchaser, and manufacturer are totaled up (step S15). FIG. 9 shows an example in which summation relating to the record number 1 is carried out.

In this example, regarding the store of ID 111, 190 Yen, which is obtained by subtracting 8 Yen of the contribution amount by the store itself and 2 Yen due to the matching gift of the purchaser (ID=222) from 200 Yen of the item cost, becomes the amount of payment from the credit card company. As for the purchaser (ID=222), 202 Yen, which is obtained by adding 2 Yen of the contribution amount to the item cost 200, becomes the amount of charge from the credit card company. Moreover, as for the manufacturer (ID=333), only 2 Yen of the contribution amount is the amount of charge by the credit card company. In the case where there is the store, purchaser, or manufacturer that do not agree to the contribution to NPO in the record, the contribution amount relating to those persons is 0 Yen, and the item cost is directly charged or paid. Then, regarding the store, purchaser, and manufacturer, the value, which is obtained by adding up the amounts of all records, is the amount of charge to those persons or the amount of payment thereto.

Next, the payment-to-store processing unit 13 performs processing for paying the item cost (amount of payment) added up in step S15 to the store (step S16). Similarly, each of the charge-to-manufacturer processing unit 14 and the charge-to-purchaser processing unit 15 charges the added amount of charge to the corresponding manufacturer and purchaser (step S17).

At this time, the contribution details outputting unit 16 prepares details for each contributor and outputs (sends) it to the store, manufacturer and purchaser (step S18). As explained above, this contribution details may be output with the cycle and timing different from payment and charge to the contributor.

Such addition processing is executed in, for example, one-month cycle as mentioned above.

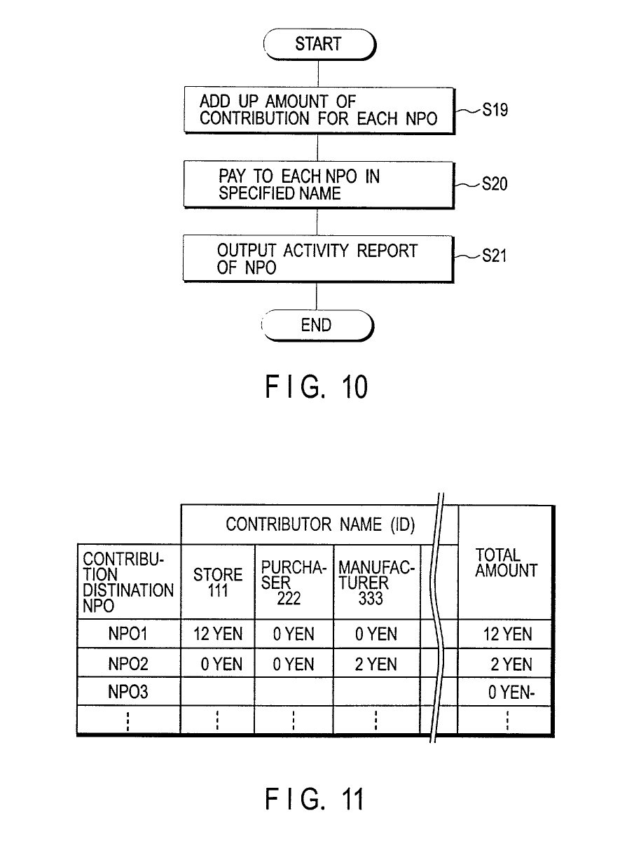

An explanation will be next given of the flow for paying the amount of contribution to the contribution destination NPO with reference to FIG. 10.

First, the contribution execution condition table 12 applies the name of NPO to data stored in the contribution execution condition table 21, and adds up the amount of contribution for each NPO (step S19). FIG. 11 shows an example in which addition relating to record number=1 is carried out.

In this example, 12 Yen where 8 Yen+2 Yen+2 Yen are donated to NPO1 in the name of the store of ID=111, and 2 Yen is donated to NPO2 in the name of the manufacturer of ID=333. Such addition processing is executed with respect to all item purchase information (records) in a predetermined period in the same way as the amount of charge to the contributor.

After that, the contribution execution-processing unit 12 performs processing for paying the contribution amount thus added to each contribution destination NPO (step S20). Here, at the time of notifying the actual amount of contribution, only the contribution amount for each name of contributor and the total amount may be displayed based on the aforementioned added data. Moreover, the activity report of each NPO prepared by the NPO report outputting unit 17 may be sent to each contributor with the same timing as the notification of amount of contribution.

The above embodiment explained the example in which the purchaser bought the item using the credit card/debit card at the actual store. The present invention is limited to the above-embodiment. For example, in the case of the so-called E-commerce in which the item and service are purchased and the payment is performed at an imaginary store on the Internet, the contribution amount may be paid based on a communication charge and a charge for connecting with a provider.

In the above-mentioned embodiment, the algorithm for determining the contribution amount of the store and the purchaser is set to “a predetermined percentage of the purchase amount” or “the same amount as the purchaser” (see FIG. 3 and FIG. 4). However, the present invention is not limited to this. For example, the amount of contribution of the store can be set to a predetermined percentage such as 50% (half amount) of the contribution amount of the purchaser or 200% (double amount) thereof. Conversely, the contribution amount of the purchaser can be set to the predetermined percentage of the contribution amount of the store.

Furthermore, the above-mentioned embodiment has explained the example in which all amounts of the contributions of the store are paid to the contribution destination NPO in the name of the store or that of the purchaser. However, the present invention is not limited to this. For example, a part of the contribution amount may be in the name of the store and the other may be in the name of the purchaser.

At the same time, in the above-mentioned embodiment, whether or not the purchaser, store, or manufacturer agrees to a contribution to an NPO is searched, and if all or some of them agree to contribute to an NPO, a contribution is performed based on the condition defined for the person. For this, by predefining who pay the contribution and under whose name in a specific program per item to be purchased (per item ID), a contribution may be executed by using an item or service as a key to search a specific contribution program.

This kind of contribution processing method can be applied to an incentive program, namely FSP (Frequent Shopper Program), in order to enclose the customers who purchase a specific item or service frequently. In this case, according to the above mentioned invention, it is possible to provide a system in which a discount portion or specified points provided by a store or manufacturer is contributed a specified NPO under the purchaser's name.

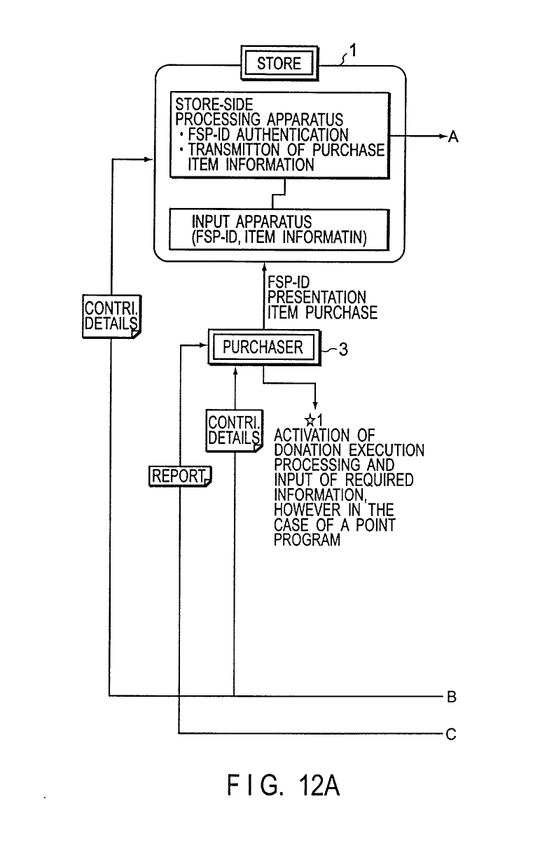

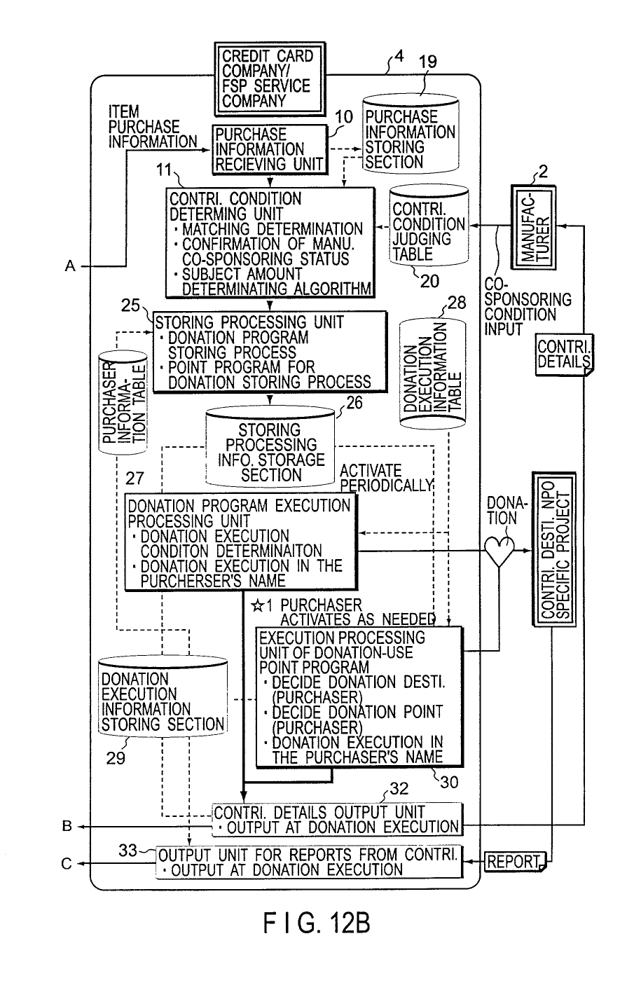

FIGS. 12A and 12B are function block diagrams showing a structural overview when this invention is applied to a FSP.

In this case, a purchaser of an item or service specified in the FSP-ID makes a contract that discount amounts or points offered at the time of settling FRP applicable items are used for a donation program or point program for donation in the purchaser's name. The above-mentioned contract is performed, in practice, in the form of an application to a super market affiliated credit card or an application to a point program of a net shopping.

Moreover, it is possible for manufacturers to involve in such a contribution program. Examples of this case could be (1) an offering of a contribution increase in the form of a discount during a specific period for a specific item (co-sponsoring with stores), (2) mailing stickers put on items (direct route with purchasers).

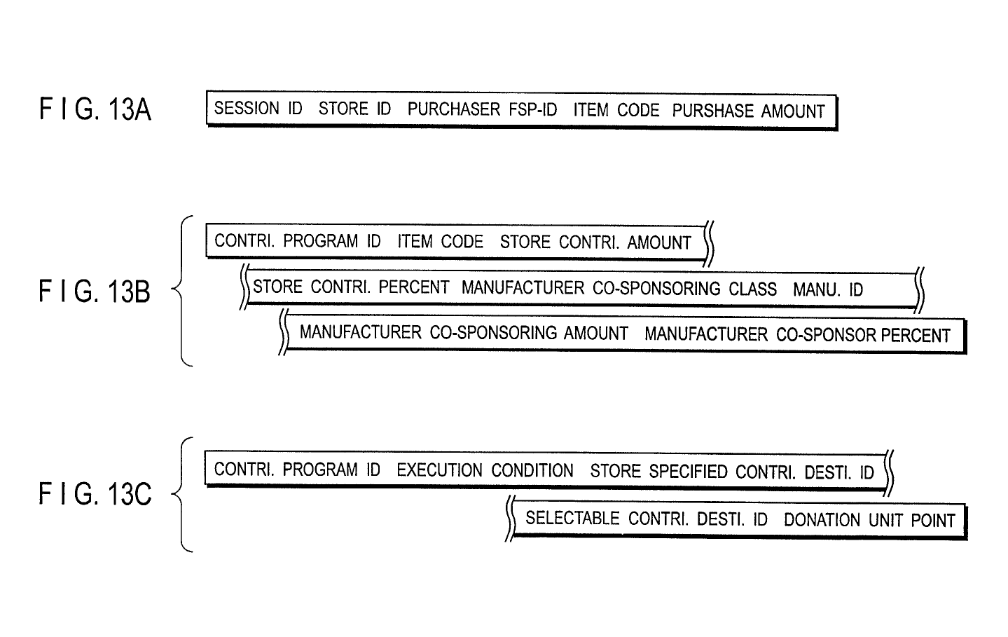

In such examples, the item purchase information transmitted to a credit company from the store-side processing unit installed in a store, shown in FIGS. 12A and 12B, contains, for example as shown in FIGS. 13A to 13C, a session ID, store ID, purchaser's FSP-ID, item code, and purchase amount. Such item purchase information is received by the purchase-information receiving unit 10 in FIGS. 12A and 12B, and stored in the purchase information storage section 19. Meanwhile, as shown in FIG. 13B, a contribution program ID, item code, store contribution amount determining algorithm, store co-sponsoring classification, Manufacturer ID, manufacturer's co-sponsoring amount determining algorithm are stored.

The contribution condition determining unit 11 judges whether or not the item regarding the purchase of the contributor concerned matches the contribution information ID of the contribution program in the above mentioned contribution condition judging table 20 based on the item purchase information stored in the above mentioned purchase information storage section 19 and the contribution program information stored in the above mentioned contribution condition judging table 20. In particular, it searches item codes within each contribution program using the item code contained in the above mentioned item purchase information and specifies the contribution program ID that matches the item code. Next, based on this contribution program ID and the purchase amount concerning the above mentioned item purchase, it determines the store's contribution-amount determining algorithm to determine the contribution amount of the store, or the manufacturer's contribution-amount determining algorithm to determine the contribution amount of the manufacturer if the manufacturer is co-sponsoring. Each contribution-amount determining algorithm may be set by an actual contribution amount or specific ratio (%) to an item purchase amount.

As described above, when an algorithm to determine a contribution amount and a purchase amount which is the basis of the calculation are specified, the storing processing of a donation program or the storing processing of a point program for donation is performed in the storing processing unit 25 shown in FIGS. 12A and 12B. Specifically, this storing processing unit 25 performs the processing of integrating and storing the contribution amounts determined by the above mentioned contribution amount determination algorithm in respect to the above mentioned purchaser. At the same time, it also computes donation points that correspond to the contribution amount determined by the above mentioned contribution amount determination algorithm, and performs the processing of storing the points for the above-mentioned purchaser. The information computed in this storing processing unit 25 by this means is saved in the storing processing information storage section 26 shown in this fig.

A donation program execution processing unit 27 starts up periodically and performs the actual processing of contributing the above-mentioned determined contribution amounts to a specific contribution destination NPO or a specific project (for example, a foundation for a specific crisis such as earth quake) in the names of contributors based on the information stored in this storing processing information storage section 26. This contribution processing is performed referring to the donation execution information table 28 shown in the figure. This donation execution information table 28 stores contribution program IDs, execution conditions, store specified contribution destination IDs, selectable contribution destination IDs and donation unit points as shown in FIG. 13C. This donation program execution-processing unit 27 searches donation execution information in the donation execution information table 28 by a contribution IDs. Next, the processing to contribute to the NPO specified by the store contribution destination ID in the donation execution information that matches the contribution program ID is performed under the above mentioned purchaser's name. Next, the results of the execution are stored in the donation execution information storage section 29.

On the other hand, the donation use point program execution processing unit 30 performs the processing that instructs the execution of the contribution when a contributor activates it as needed and decides a contribution destination NPO and donation point number. That is, this donation use point program processing unit 30 fetches selectable contribution destination IDs and donation unit points from the donation execution information stored in the above mentioned donation execution information table 28 (FIG. 13C)) based on the instruction of the contributor. Next, based on this information, it lets the above-mentioned purchaser specify a contribution destination NPO and a contribution point number, then based on that, a contribution processing to the NPO and the others is performed. Next, the execution results of this donation use point execution processing is stored in the donation execution information storage section 29 in the same way as the above mentioned one.

Next, similarly to the above-mentioned embodiment, the execution results of the units 27 and 30 are output from the contribution details output unit 32, and sent to the store 1 and the manufacturer 2 that are relevant to this contribution. Meanwhile, for the purchaser 3 the contribution destination report output unit 33 outputs execution results with the report from the above mentioned contribution destination NPO.

It is preferable the output format of reports to the purchaser is decided when this credit card company and the purchaser make a contract, and it is preferable to store this kind of information in the purchaser information storage table 34.

In such a configuration, whenever a specific item or service is purchased, a point equivalent to the discount amount set to this item or service is contributed to a specific NPO in the name of the purchaser. As a result, for the purchaser it becomes an incentive to purchase the specific item or service, and it becomes possible to promote a sale of the specific item or service.

As explained above, the present invention can provide a method and a system that give an opportunity for making contributions to charity donations such as NPOs with respect to sellers and manufactures, who have high awareness of contributing to society, based on a predetermined agreement about contributing to NPOs, at the time when a purchaser buy an item or service using a credit card, whereby increasing donations to NPOs.

What is claimed is:

1. A computer implemented method for processing charity contribution comprising the steps of:
(a) receiving the charge for a cost relating to a purchase concerned from a store where a purchaser purchases an item or service using a credit/charge;
(b) searching whether or not said store or manufacturer of said item or service is a member that agrees to a contribution to a charity and determining the algorithm to determine its amount of contribution and the designated charity for the contribution when said store or manufacturer is such a member; and
(c) paying the amount, which said algorithm determined in said step (b), is applied to said cost relating to the purchase to said designated charity determined in said step (b) as a amount of contribution.

2. The method according to claim 1, wherein said step (c) is performed to pay said amount of contribution to said designated charity as a contribution of said store or/and manufacturer.

3. The method according to claim 1, wherein said step (c) is performed to pay said amount of contribution to said designated charity as a contribution of said purchaser.

4. The method according to claim 1, further comprising the step (d) of paying the amount obtained by subtracting said amount of contribution from the cost relating to said charge.

5. The method according to claim 4, wherein said step (d) includes the step of issuing details of the purchase amount relating to said payment and details of the contribution amount to said designated charity to said store or/and manufacture.

6. The method according to claim 1, further comprising the step (e) of notifying said purchaser of the information of which the contribution concerning the purchase of said purchaser is performed.

7. The method according to claim 1, further comprising the step of
(f) receiving details of the item or service relating to the purchase concerned;
and wherein said step (b) searches whether or not the manufacturer of the item is a member that agrees to charity contributions based on said details and determines the algorithm to determine its amount of contribution and the designated charity when said manufacturer is such a member.

8. The method according to claim 1, further comprising the steps of:
(g) searching whether or not said purchaser of the item is a member that agrees to a contribution to a charity and determining the algorithm to determine the amount of contribution and the designated charity when said purchaser is such a member;
(h) paying the amount in which said algorithm is applied to the item purchase cost relating to said purchase of said purchaser to said designated charity as the amount of contribution from said purchaser; and
(i) charging said purchaser for the amount obtained by adding said amount of contribution to said purchase cost.

9. The method according to claim 8, wherein said algorithm for determining the amount of contribution of said store or manufacturer determined in said step (b) is set such that the amount of contribution of the store/manufacturer is a predetermined percentage of the amount of contribution from said purchaser or the same as the amount of contribution from said purchaser.

10. The method according to claim 9, wherein said algorithm for determining the amount of contribution of said purchaser determined in said step (g) is set such that the contribution amount of the purchaser is a predetermined percentage of the amount of contribution from said store or manufacturer or the same as the amount of contribution from said store or manufacturer.

11. The method according to claim 8, wherein said step (b) determines the designated charity of the purchaser determined in said step (g) as the designated charity of the store or manufacturer.

12. The method according to claim 8, wherein said step (g) determines the designated charity of the store or manufacturer determined in said step (b) as the designated charity of the purchaser.

13. The method according to claim 1, wherein said step (c) is performed to pay a part of said amount of contribution to said designated charity as the contribution of said store or manufacturer, and the other part of said amount of contribution to said designated charity as the contribution of said purchaser.

14. A system for promoting contributions to charities in association with purchases using credit/charges, said system comprising:
a purchase information receiving means for receiving purchaser's purchase information of an item or service using a credit/charge wherein said purchase information includes at least the information of the store at which said purchaser performs the purchase and information of the purchase cost at said store;
a contribution condition determining means for searching whether or not said store or the manufacturer of said item or service is a member who agrees to a contribution to a charity and determining contribution conditions such as the algorithm to determine the amount of contribution and designated charity when said store or manufacturer is such a member; and
a contribution payment processing means for paying the amount in which said algorithm is applied to said purchase cost to said designated charity as the amount of contribution.

15. The system according to claim 14, wherein said contribution amount payment processing means is used to pay said amount of contribution to said designated charity as the contribution of said store or/and manufacturer.

16. The system according to claim 14, wherein said contribution amount payment processing means is used to pay said amount of contribution to said designated charity as the contribution of said purchaser.

17. The system according to claim 14, further comprising purchase cost payment processing means for paying an amount obtained by subtracting said contribution amount from the cost relating to said charge.

18. The system according to claim 14, further comprising a contribution details issuing section for issuing details of the purchase amount relating to said payment and details of the amount of contribution to said designated charity to said store or/and manufacturer.

19. The system according to claim 14, further comprising a contribution information notifying section for notifying said purchaser of information of the contribution, which said store/manufacturer has made to said designated charity, concerning the purchase of said purchaser.

20. The system according to claim 14, further comprising an item purchase details receiving section for receiving details of the item relating to the purchase concerned from said store;
and wherein said contribution condition determining means searches whether or not the manufacturer of the item is a member that agrees to a contribution to a charity based on said details to determines contribution conditions such as the algorithm to determine the amount of contribution and designated charity when said manufacturer is such a member.

21. The system according to claim 14, further comprising:
a contribution condition determining means for searching whether or not said purchaser of the item is a member that agrees to a contribution to a charity and determining contribution conditions such as the algorithm to determine the amount of contribution and the designated charity when said purchaser is such a member;
a contribution payment processing means for paying the amount in which said contribution conditions are applied to the item purchase cost relating to said purchase of said purchaser to said designated charity determined based on said contribution condition as the amount of contribution from said purchaser; and
a charge processing means for charging said purchaser for the amount obtained by adding said contribution amount to said purchase cost.

22. The system according to claim 21, wherein said algorithm for determining the amount of contribution of said store or manufacturer determined in said contribution determining means is set such that the amount of contribution of the store or manufacturer is a predetermined percentage of said amount of contribution from said purchaser or the same as the amount of contribution from said purchaser.

23. The system according to claim 21, wherein said algorithm for determining the amount of contribution of said purchaser determined in said contribution condition determining means is set such that the amount of contribution of the purchaser is a predetermined percentage of said amount of contribution from said store or manufacturer, or the same as the amount of contribution from said store.

24. The system according to claim 21, wherein said contribution condition determining means determines the designated charity of said purchaser as the designated charity of the store or manufacturer.

25. The system according to claim 21, wherein said contribution condition determining means determines the designated charity of said store or manufacturer as the designated charity of the purchaser.

26. The system according to claim 14, wherein said contribution amount payment processing means pays a part of said contribution amount to said designated charity as the contribution of said store or manufacturer and the other part of said amount of contribution to said designated charity as the contribution of said purchaser.
